(19) United States
(12) Patent Application Publication
(10) Pub. No.: US 2002/0194588 A1
(43) Pub. Date: Dec. 19, 2002

(54) Commercial deleter

(76) Inventor: Peter Vogel, Faulconbridge (AU)

Correspondence Address: FISH & RICHARDSON, PC, 4350 LA JOLLA VILLAGE DRIVE, SUITE 500, SAN DIEGO, CA, 92122, US

(21) Appl. No.: 10/168,281

(22) PCT Filed: Dec. 20, 2000
(86) PCT No.: PCT/AU00/01573

(30) Foreign Application Priority Data
Dec. 21, 1999 (AU) PQ 4743

(51) Int. Cl. H04N 7/16; G06F 15/173; G09G 5/00

(52) U.S. Cl. 725/25; 709/225; 345/741; 725/28

(57) ABSTRACT

Signals identifying the content of television programs are served to the internet by a central server and received from the internet in viewers' homes. A controller uses these signals to control recording or viewing of a television program according to the identifying signals received.

### FIELD OF THE INVENTION

The present invention relates to systems for deleting unwanted material from video recordings or television viewing.

### BACKGROUND OF THE INVENTION

Many systems have been proposed for removing commercials or other unwanted material from television programs. One effective system is described in U.S. Pat. No. 5,371,795 to Vogel which is hereby incorporated by reference for all purposes. In Vogel's system, a number of people monitor broadcasts as they go to air. These people then enter data into a computer as the content of a channel changes. When a commercial starts on a particular channel, the monitoring person presses a button that causes a signal to be transmitted to viewers' homes indicating that a commercial is in progress on the channel concerned. Equipment at the viewer's home recognises this signal, and if the channel indicated by the signal is being viewed or recorded, the television receiver or video recorder is disabled until the commercial break is finished, as indicated by receipt of another signal constituted for this purpose.

Other systems, such as pattern recognition systems that recognise commercials, can also be utilized with good results. Many systems of this type, however, are complex and expensive. It is desirable, therefore, that such systems perform the commercial-recognising function at a central office, and that the control signals be broadcast to multiple users. This amortizes the cost of the complex part of the system over many users.

Various systems have been proposed for broadcasting the commercial deleter control signals from a central office to users' homes. In U.S. Pat. No. 5,371,795 the signals are conveyed by a radio paging network. This system is effective, although implementation may be problematic in areas where paging coverage is not reliable, or where the paging network is not available or is fully occupied with other traffic. Other systems have been proposed utilising the vertical blanking interval (VBI) of a television signal for the control signals. This system is of limited application since it is necessary to have the cooperation of the television service operators for implementation. The receivers to decode the VBI signals also tend to be costly.

### SUMMARY OF THE INVENTION

It is an object of this invention to provide a system and process which deletes commercials from television viewing or recording utilising the internet as a means of conveying realtime control signals from a central server to multiple user sites.

In one embodiment, the present invention provides a program identifying system comprising a server which serves signals to the internet using an internet protocol, said signals identifying the classification of programs being broadcast on each of the available channels.

In certain embodiments the classification can include the rating of the program or the genre of the program, or the classification can identify commercials breaks.

In yet another embodiment, the present invention provides a program controller comprising computing means adapted to receive realtime control signals from a remote server using an internet protocol and, according to user input to said computing means, control display, audition or recording of programs.

In another embodiment, the server can be further adapted to send only those control signals which relate to a particular channel or channels requested by a remote user. For example, a user wishing to delete commercials from a program on channel 30 might instruct the server to send only information relating to channel 30 via the data stream being used by his controller.

In yet another embodiment, the present invention provides a program controller comprising computing means adapted to receive realtime control signals from a remote server using an internet protocol and control means adapted to control program recording means so that recording is suspended while the realtime control signals indicate that non-program material is being broadcast on a channel from which a program is being recorded. Non-program material can include commercial breaks, station promotions, or any other material that is not part of the program being viewed. In some embodiments the user may specify which types of material are to be treated as non-program material.

In some of the foregoing embodiments, the invention can use polling of the remote host to obtain the realtime control signals. In others, a push protocol, whereby messages are sent to clients spontaneously, can be used, which does not require polling and generally provides faster response.

In other embodiments, the invention can use multiple servers serving the same control data or subsets of the same control data to the internet. This may be desirable as use of multiple servers strategically located can reduce response time and reduce bandwidth consumption of the internet. Furthermore, the realtime control data will generally be specific to a particular geographic location, hence it is wasteful to make data available to areas where this data is of little value.

In some embodiments, the realtime control signals are served using internet protocol multicasting. In other embodiments the realtime control signals are served using other protocols, for example hypertext transfer protocol (HTTP) or user datagram protocol (UDP). In case of network failure or unacceptable network delay, some embodiments of the invention are further adapted to recognise loss of user datagrams, or lack of response to a HTTP or other request, for a period exceeding a preset period to cause a default program identifier to be used. For example UDP can be used to convey the instantaneous status of either commercial or program. However as UDP is not guaranteed to reach the destination, it would be possible that a video recorder could be erroneously left in the paused state due to failure to receive a “commercial” UDP signal. Using the foregoing embodiment of the invention, however, loss of UDP datagrams for a period of greater than one second, for example, would be interpreted as the default identifier of “program”, so that recording would resume. If subsequent datagrams indicated “commercial”, recording would again be paused. If subsequent datagrams indicated “program” then recording would simply continue. In cases where the recording device can be controlled sufficiently accurately, any errors can be corrected by repositioning the recording point appropriately in the event of data loss and consequent unwanted recording of commercials.

In other embodiments, timestamps are included in the internet messages so that the receiving controller can compensate for propagation delays. For example, if the signals are being used to delete commercials from a recording, the recording device can be “rewound” to the exact point at which recording of the commercial started, as indicated by the timestamp received.

In another embodiment, alternative program material is substituted for unwanted material. This alternative material can conveniently be provided via the internet, or from any other source.

The invention also consists in recording apparatus which includes the inventive features according to the foregoing description.

Furthermore, the invention also consists in a controller which provides the inventive features according to the foregoing description which is separate from a recording means and controls it by suitable signaling.

### DESCRIPTION OF PREFERRED EMBODIMENTS

Embodiments of the invention will now be described with reference to the drawings in which:

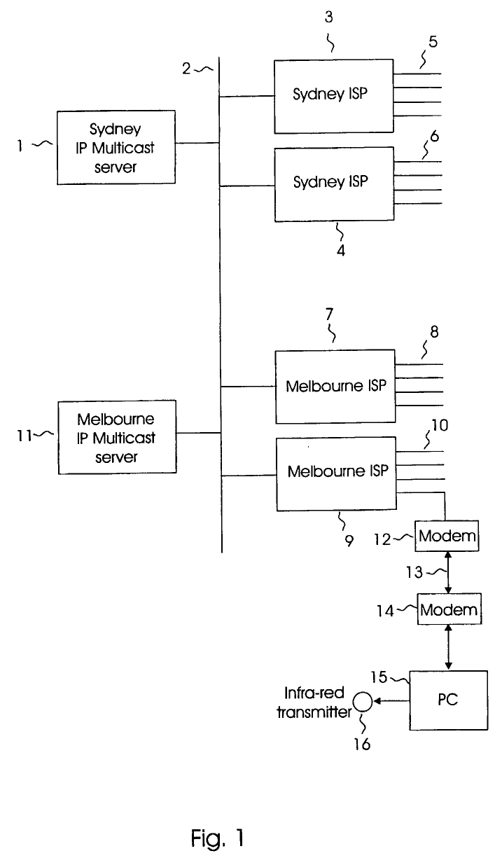

FIG. 1 is a block diagram of an embodiment of the present invention utilizing internet protocol multicast (IP multicast) for real-time control.

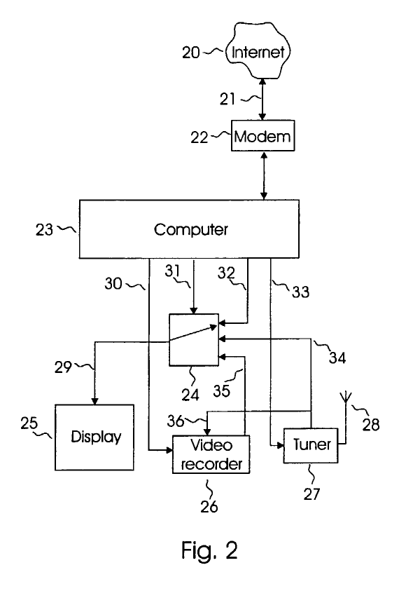

FIG. 2 is a block diagram of an embodiment of the present invention in which a computer, video display, video recorder and tuner are combined in a single piece of equipment.

Referring now to FIG. 1, there is shown a block diagram of an embodiment of the invention which uses IP multicast to convey the real-time controls.

The diagram includes an exemplary section of the internet, conventionally comprising backbone 2, and internet service providers (ISPs) connected to the backbone. In this example, Sydney ISP 3 and Sydney ISP 4 are located in Sydney and Melbourne ISP 7 and Melbourne ISP 9 are located in Melbourne. The ISPs are connected to customers via dial-in or other connections, shown as 5,6,8, and 10.

As the realtime-data to be served to users is unique to each of the cities shown, separate multicast servers, Sydney IP multicast server 1 and Melbourne IP multicast server 11, are provided. These are located in the appropriate geographical region so that when accessed by local users the data passes through a minimum number of routers, hence minimizing response time and bandwidth.

The user's personal computer, PC (personal computer) 15, is connected to the internet via modem 14 which communicates via phone line 13 to modem 12 which is connected to one of the ports provided by Melbourne ISP 9.

The user of the system, operating PC 15, accesses the service via a conventional web browser, using an HTTP (hypertext transfer protocol) page. This page generates little traffic, as it is only used for establishing connection and other administrative purposes, so it is not necessary to have multiple sites dedicated to geographical regions; one can serve all. This HTTP site can be hosted anywhere on the internet. The HTTP page connects the user to the appropriate IP multicast server depending on the user's location, which can be determined automatically from the internet protocol address information, or from information entered by the user.

In some cases it may be desired to charge users for access to the service. This can conveniently be handled using the well-known internet electronic commerce techniques.

Once PC 15 is receiving the multicast data, it executes a monitoring task which monitors the multicast data looking for changes in status on the channel being recorded or viewed. The channel of interest can be entered by the user or detected automatically by the PC, for example by interrogating a suitably-interfaced VCR or television receiver. When a commercial break starts, data indicating this changed status is detected by the recording task, which in turn issues a “pause” command to the VCR via IR transmitter 16. Similarly, when the commercial break finishes, a “resume recording” signal, which for most VCRs is the “record” signal, is issued.

In this embodiment, IR transmitter 16 is connected to the PC through the standard PC serial port, and includes the required interface and driver circuitry to receive serial characters and perform the necessary translation to a modulated serial bit stream as required for infra-red remote controllers.

In this manner the invention can be used to eliminate ads from a recording or from television viewing. When used for viewing, the control signals can be arranged to mute the receiver's sound completely or partially, to blank the screen, to display alternative material, or any other convenient response.

The realtime data used by this and other embodiments can be provided by a number of methods. One effective system is to use a number of people monitoring broadcasts as they go to air. These people then enter data into a computer as the content of a channel changes. Improved methods of performing this monitoring method are described in U.S. Pat. No. 5,371,795 to Vogel. Other systems, such as pattern recognition schemes, can also be utilized with good results.

To allow the invention to be used to control a variety of VCR models, a web page for configuration of infra-red codes is made available as part of the service. This page allows the user to select the brand and model of VCR they wish to use, and the appropriate infra-red control codes are downloaded to PC 15.

Referring now to FIG. 2, another embodiment of the invention will be described. In this embodiment, the invention is incorporated into a single piece of equipment which comprises an internet-capable computer, visual display device, VCR and tuner. This may comprise a so-called “web TV” or could be a personal computer fitted with a TV tuner board and interfaced to a VCR or other recording device such as DVD (Digital Versatile Disk).

Realtime control data is served to the internet in the same way as described above for the embodiment of FIG. 1, this part of the system not being shown in FIG. 2. The realtime control data is received by computer 23 from the internet 20 via an ISP link 21 and modem 22.

Display 25 is fed signal via selector 24 which, under control of computer 23, can select program from video recorder 26 via video output 35, tuner 27 via video output 34, or video output 32 of computer 23. Video output 32 of computer 23 in this embodiment is derived from the computer's graphics subsystem, so that when this output is selected for display, the user can view web pages, email messages, or any other computer graphics.

Computer 23 also controls channel selection of tuner 27 and transport control of video recorder 26. The user interface for video recording and television functions can therefore be provided via a graphical user interface.

When in television viewing mode, programs received by antenna 28 are demodulated by tuner 27, the output of which is conveyed via signal 34 to selector 24. Selector 24 is instructed by computer 23 via control signal 31 to select the tuner's signal for feeding to video recorder input 29.

Once computer 23 is receiving the multicast realtime control data, it executes a monitoring task which monitors the multicast data looking for changes in status on the channel being recorded or viewed. In this case computer 23 knows which channel is being watched, and therefore which signals are relevant to controlling viewing at that time.

When a commercial break starts, data indicating this changed status is detected by the recording task, which in turn instructs selector 24 to select the computer's graphic signal 32 as its source. Depending on setup options selected by the user, the computer may generate a blank screen, or a message announcing that an ad is in progress.

Alternatively, the user may request that a different program source be viewed during the commercial break. For example, the user may set up a profile of goods or services which are of interest, and advertisements of this type can be inserted instead of the commercials being received by tuner 27. These advertisements may originate from the internet, in the form of web pages, streaming video and audio, or other internet media. Such advertising can be enhanced by being interactive, or by allowing goods to be purchased on-line, or many other beneficial features.

Other sources of alternative material may be used with good results, for example a video tape or DVD could be played. Another option is to change the channel being received by tuner 27 during a commercial break, instead of changing the source of selector 24. This is advantageous if, for example, a channel of entertainment is provided on a channel dedicated for this purpose, such as music with visual wallpaper, or rock clips. It is even possible to have alternative television commercials available, for example community announcements of more interest to the user than the commercials interrupting the program being viewed.

An attractive educational extension of this embodiment provides educational information, which may for example be interactive quizzes read from a CD-ROM or DVD interfaced to computer 23.

It will be understood that although the description of this embodiment describes controlling of the picture displayed, the sound component of the program is also switched appropriately. One additional option is that the user may select that during commercial breaks the picture continues to be displayed, but the sound is either muted completely or reduced in volume.

This embodiment can of course also be used to excise commercials while recording programs, as described for the embodiment of FIG. 1 except that in this case computer 23 has direct control of video recorder 26 and rather than by means of infra-red signaling. The computer commands tuner 27 to tune the required channel via control signal 34, and the demodulated video signal is fed to the recording input of video recorder 26 via signal 36.

It will also be understood that whereas both embodiments refer to excluding commercials, the present invention can also be applied with good effect to removing material of other types. For example, the realtime control signals can also include program ratings, so that programs or even scenes, which are of a type selected by the user as being unsuitable can be eliminated from viewing or recording. Of course, the same system can be used to select types of material to be included, rather than excluded, or a mix of both inclusion and exclusion. For example, the user could configure the system to include all programs rated for children's viewing, while excluding all commercials or scenes with sexual references.

Another beneficial use of the invention is to control viewing or recording of a series of programs, so that a user can create their own personalized programming. In this application the realtime control signals identify each program by title or other unique identifier. The user specifies which programs are to be viewed or recorded, and as these programs start and finish, the tuner is tuned to the appropriate channel and the video recorder and display are controlled accordingly, with the result that the lineup of programs requested are recorded or presented for viewing sequentially.

It will be understood that certain modifications and extensions of the inventive concept will be obvious to those skilled in the art and can be made without departing from the scope of the present invention.

For example, the invention is applicable to all recording means, including, for example DVD, VCR, and hard-disk based recorders. The invention can also be used for controlling audio recorders.

Furthermore, although some of the embodiments use infra-red signaling to control the recorder, other means of control can be used with good effect. In particular, if the VCR is equipped with a suitable control interface, such as a serial port, a direct connection can be made between the controller of the invention and the VCR to be controlled. Other forms of wireless control systems can also be used with good effect.

Whereas the exemplary embodiments herein utilise a personal computer as the web-browsing means, it is of course possible to use other types of computer, such as an embedded microcontroller, instead.

The invention can also be incorporated into other equipment, for example built into a VCR, personal computer or television receiver.

Whereas the embodiments described herein describe the internet connection as being made via telephone line and modem, the invention can also use other forms of internet connection, such as a cable service or wireless connection.

1. A broadcast program editing system comprising:
at least one server which transmits to the internet messages identifying at least one program being broadcast in a specified region; and
a controller adapted to receive said messages from the internet and control viewing or recording of broadcast programs according to the content of said messages.

2. A system according to claim 1 wherein said identifying messages signal the commencement or completion of broadcast of non-program material.

3. A system according to claim 1 wherein said identifying messages indicate the rating of a broadcast.

4. A system according to claim 1 in which the identifying messages identify specific program titles.

5. A system according to claims 1-4 wherein said identifying messages relate to a particular broadcast channel specified by the user of said controller.

6. A system according to claims 1-4 in which multiple servers are utilised to deliver identifying messages to the internet and said servers are adapted to serve identifying messages relevant only to particular geographical regions.

7. A system according to claim 1 in which said server serves the identifying messages to the internet in response to a request from a remote source.

8. A system according to claim 1 in which said server serves the identifying messages to the internet using a push protocol.

9. A system according to claim 1-8 in which the identifying messages include a timestamp.

10. A system according to claim 1 wherein said controller is further adapted so that in the event of communication with the server being lost for longer than a prescribed time, recording or viewing of the program is controlled according to a predetermined default algorithm.

11. A system according to claim 10 wherein said default algorithm dictates that if communication with the server is lost for longer than a prescribed time while viewing or recording of a program has been interrupted by said controller, recording or viewing of the program is resumed.

12. A system according to claim 10 wherein said default algorithm dictates that if communication with the server is lost for longer than a prescribed time while viewing or recording a program, recording or viewing of the program is interrupted.

13. A program controller comprising computing means adapted to receive identifying messages from the internet and control means adapted to control program recording means so that recording is suspended while the identifying messages indicate that non-program material is being broadcast on a channel being recorded.

14. A program controller comprising computing means adapted to receive identifying messages from the internet and control means adapted to control program viewing means so that viewing is suspended while the identifying messages indicate that non-program material is being broadcast on a channel being viewed.

15. A program controller comprising computing means adapted to receive identifying messages from the internet and control means adapted to control program reproduction means so that the sound level of reproduction is reduced while the identifying messages indicate that non-program material is being broadcast on a channel being reproduced.

16. A program controller comprising computing means adapted to receive identifying messages from the internet and control means adapted to control program recording means so that recording is started when the identifying messages indicate commencement of broadcast of a particular program and recording is stopped when the identifying messages indicate completion of broadcast of a particular program.

17. A program controller comprising computing means adapted to receive identifying messages from the internet and control means adapted to control program reproduction means so that reproduction is started when the identifying messages indicate commencement of broadcast of a particular program and reproduction is stopped when the identifying messages indicate completion of broadcast of a particular program.

18. A program controller comprising computing means adapted to receive identifying messages from the internet and control means adapted to control program recording or reproduction means according to the content of said identifying messages by transmitting suitable remote-control signals to said recording or reproduction means.

19. A program controller comprising:
computing means adapted to receive identifying messages from the internet;
audio-visual display means; and
control means adapted to switch the input of said display means between two or more sources according to the content of said identifying messages.

20. An audio-visual display system comprising:
computing means adapted to receive identifying messages and web pages from the internet;
a television program receiver;
audio-visual display means; and
control means adapted to cause said display means to display either said received web pages or said received television programs according to the content of said identifying messages.

21. An audio-visual display system comprising:
computing means adapted to receive identifying messages and web pages from the internet;
a television program receiver;
audio-visual display means; and
control means adapted to cause said display means to display said received web pages while the content of said identifying messages indicates that a television program being received is of a type selected by the user for exclusion.

22. A program controller substantially as hereinbefore described, with reference to the accompanying drawings.

23. A program control method substantially as hereinbefore described, with reference to the accompanying drawings.
